(19) United States
(12) Patent Application Publication
(10) Pub. No.: US 2011/0155749 A1
(43) Pub. Date: Jun. 30, 2011

(54) GERM GUARD LABEL AND METHODS FOR USING GERM GUARD LABEL

(76) Inventor: Kathryn Jeanne Neiheiser, Strongsville, OH (US)

(21) Appl. No.: 12/875,406

(22) Filed: Sep. 3, 2010

Related U.S. Application Data
(60) Provisional application No. 61/290,089, filed on Dec. 24, 2009.
(60) Provisional application No. 61/321,476, filed on Apr. 6, 2010.

(51) Int. Cl. B65D 90/00; B29C 65/02; B32B 38/16; B29C 51/00

(52) U.S. Cl. 220/694; 156/85; 156/281; 156/212

(57) ABSTRACT

Aspects include a germ guard label and methods for using the germ guard label that can prevent transmission of germs. For example, the germ guard label can shield an object (e.g., a beverage container oral contact area) from germs and other contaminants. The germ guard label can be constructed from a food grade material treated with antimicrobial agents that can be removeably attached to the object (e.g., by a thermoforming process).

### CROSS-REFERENCE TO RELATED CASES

The present application claims the priority of and expressly incorporates by reference the following applications: U.S. Provisional Patent Application Ser. No. 61/290,089, “GERM GUARD LABEL AND METHODS FOR USING A GERM GUARD LABEL,” which was filed on Dec. 24, 2009 and U.S. Provisional Patent Application Ser. No. 61/321,476, “GERM GUARD LABEL AND METHODS FOR USING A GERM GUARD LABEL,” which was filed on Apr. 6, 2010.

### TECHNICAL FIELD

Described herein are germ guard labels and, in particular, systems and methods employing germ guard labels to shield oral contact areas to prevent disease transmission.

### BACKGROUND

Consumers purchase millions of beverage containers each day, including take out cups, cans and bottles. Beverage containers can be purchased, for example, from take out counters, from vending machines or from grocery stores. Even before reaching the store, beverage containers can be contaminated with dirt and grime from the packaging and shipping process. Once they reach the store, beverage containers can be contaminated with disease-causing germs from employees who touch the beverage containers.

For example, an employee may come to work at a store that sells beverages while suffering from a cold, influenza, or other contagious disease. When that employee touches the beverage container (e.g., places a lid on a cup of coffee or grabs a beer bottle from a refrigerator), the beverage container can become contaminated with germs. When the purchaser drinks the beverage, the germs are transferred from the beverage container to the purchaser.

### SUMMARY

The following presents a simplified summary of the invention in order to provide a basic understanding of some aspects of the invention. This summary is not an extensive overview of the invention and is not intended to identify key/critical elements of the invention or to delineate the scope of the invention. Rather, the sole purpose of this summary is to prevent some concepts of the invention in a simplified form as a prelude to the more detailed description that is presented later.

Described herein is a germ guard label that can prevent contamination of an object and methods of using the same. For example, an object can include a beverage container or a portion of a beverage container. A beverage container can include, for example, a cup, a lid for a cup, a cup and a lid together, an aluminum can, a bottle, etc. A contaminant can include, for example, germs, like bacteria or viruses, fungi, heavy metals or dirt.

A germ guard label can be a food grade material. Additionally or alternatively, the germ guard label can be treated with antimicrobial agents and/or can possess antimicrobial properties. Additionally or alternatively, the germ guard label can be removably attached to the object. The germ guard label can be removably attached, for example, by methods that do not utilize an adhesive (e.g., thermoforming, vacuumforming, or static electricity).

The germ guard label can shield the object from contaminants, including communicable diseases like influenza, the common cold, streptococcus or staphylococcus. For example, when a person carrying germs, like influenza, touches an object covered with a germ guard label, germs transmitted from the germ carrying person can contaminate the germ guard label rather than the object. Another person can remove the contaminated germ guard label from the object (e.g., by pulling on tab), and the area of the object covered by the germ guard label (e.g., the oral contact area) will be substantially germ free. The germ guard label also can prevent spillage of a substance from the oral contact area (e.g., spillage of coffee from a cup through the oral contact area). Additionally or alternatively, the germ guard label can be constructed from one or more recyclable materials.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and features of the invention will become apparent from the following detailed description of the invention when considered in conjunction with the drawings.

### BRIEF DESCRIPTION OF THE DRAWINGS

FIGS. 1A-E are illustrations of exemplary embodiments of a germ guard label.

FIG. 2 is an illustration of a method for making an article that prevents transmission of a contaminant from an object to a human.

FIG. 3 is an illustration of a method for applying a germ guard label to an object.

FIG. 4 is an illustration of a method for thermoforming a germ guard label to an object.

FIG. 5 is an illustration of a method for preventing transmission of germs from an object to a human.

FIG. 6 is an illustration of a method for applying a germ guard label to a clean object to prevent transmission of a contaminant from the object to a human.

FIG. 7 is an illustration of a method for applying a germ guard label to a clean, dry object to prevent transmission of a contaminant from the object to a human.

FIG. 8 is an illustration of a method for applying a germ guard label to a sterile object to prevent transmission of germs from the object to a human.

FIG. 9 is an illustration of a method for applying a germ guard label to a clean, sterile object to prevent transmission of a contaminant or germs from the object to a human.

FIG. 10 is an illustration of a method for applying a germ guard label to a clean, dry, sterile object to prevent transmission of a contaminant or germs from the object to a human.

### DETAILED DESCRIPTION

Described herein are germ guard labels and, in particular, systems and methods that employ germ guard labels to prevent transmission of germs and other contaminants from an object to a human.

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

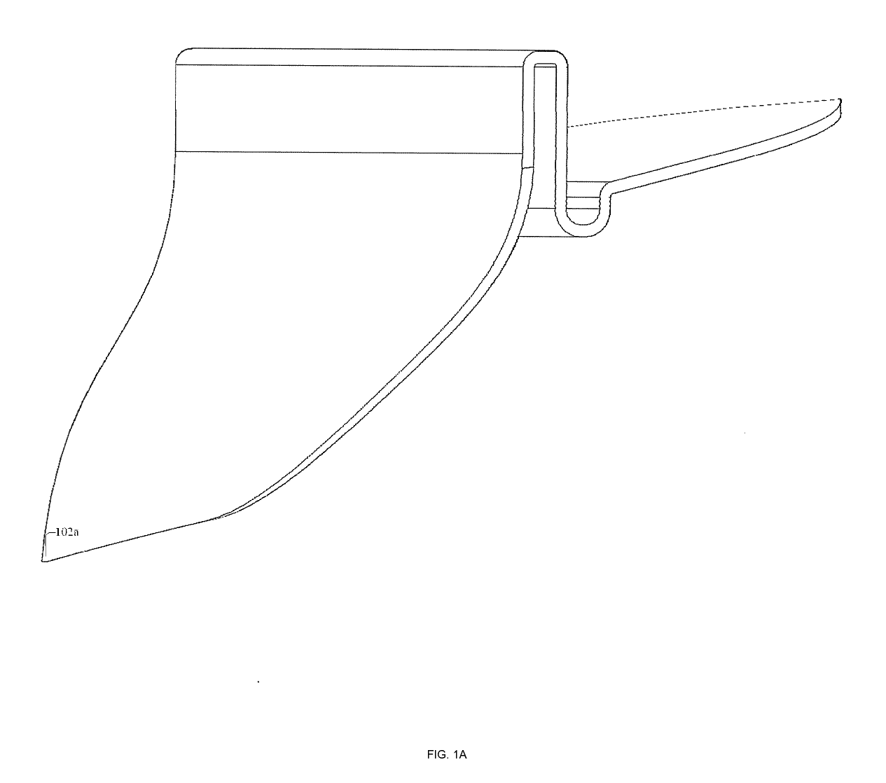

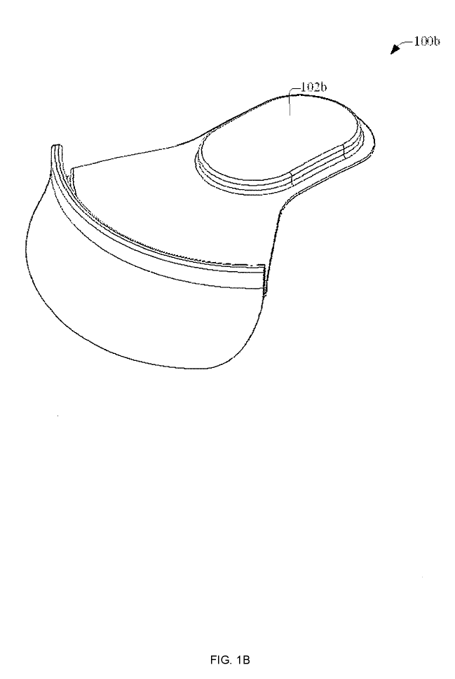

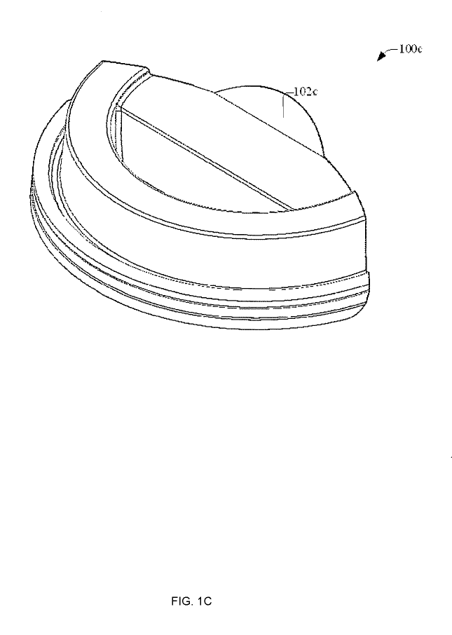

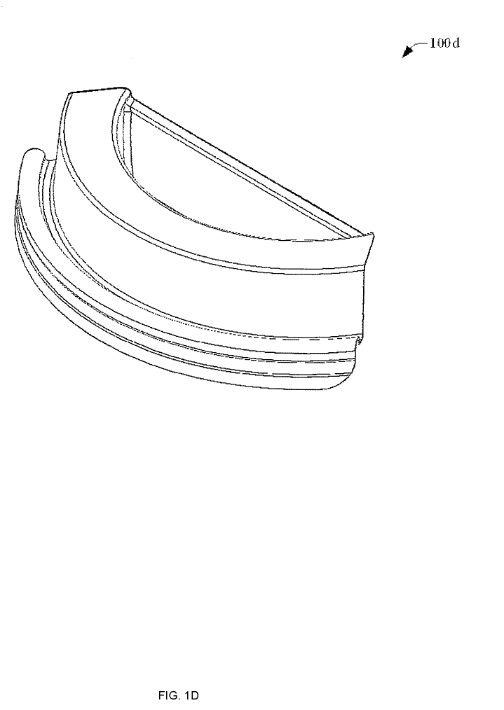

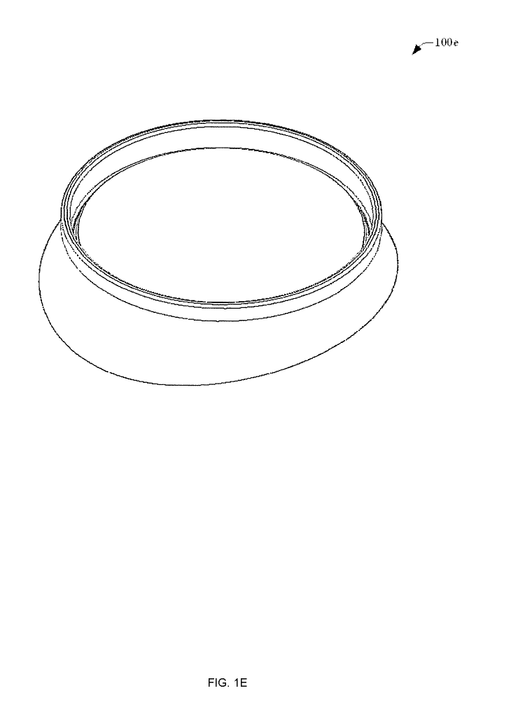

Referring to FIGS. 1A-1E, structures 100a-100f are shown to illustrate exemplary germ guard labels that can cover a coffee cup lid. Germ guard labels can cover a portion of the lid, as illustrated in FIGS. 1A, 1B, 1C, and 1D, or the entire lid, as illustrated in FIG. 1E. Germ guard labels can cover any portion of the lid, as long the germ guard labels at least cover an entire oral contact area of the lid. Additionally, germ guard labels can be of any shape as long as the entire oral contact area is covered. The embodiment of a coffee cup lid is merely exemplary and not exclusive; the germ guard label can cover any oral contact area of any beverage container (e.g. a can or a bottle).

By covering at least the oral contact area of the lid, germ guard labels can act as a physical barrier and/or shield to limit or prevent the spread of germs and other contaminants. Contaminants can include germs (e.g., influenza, the common cold, streptococcus or staphylococcus), dirt, fungus or heavy metals. For example, when a person infected with germs like influenza touches an object covered with the germ guard label, germs transmitted from the infected person can contaminate the germ guard label rather than the object. The same is true for other contaminants. Another person can remove the contaminated germ guard label from the object (e.g., by pulling a tab), and the area of the object covered by the germ guard label (e.g., the oral contact area) will be substantially germ free. The germ guard label also can prevent spillage of a substance from the oral contact area (e.g., spillage of liquid contained in a cup or can through an oral contact area of an associated lid).

The germ guard labels as illustrated in FIGS. 1A-1E can have a thickness between a thin film and the lid itself. For example, the thickness of the germ guard layer can be between 0.01 and 150 millimeters. Further for example, the thickness of the germ guard layer can be between 1 and 90 millimeters. Furthermore, for example, the thickness of the germ guard layer can be between 10 millimeters and 45 millimeters.

Additionally or alternatively, as illustrated in FIGS. 1A-1E, germ guard labels can be removably attached to the object. Germ guard labels can be removably attached by an adhesive approved by the U.S. Food and Drug Association (FDA) for direct food contact. However, preferably, the germ guard labels can be removably attached to the object without utilizing an adhesive. For example, germ guard labels can be attached to the object via thermoforming or static cling.

Thermoforming (or vacuumforming) allows the germ guard label to fit exactly flush against the object until it is physically removed. The germ guard label can be thermoformed to the object so that it is conformal or substantially conformal with the oral contact area of the object.

The process of thermoforming heats a plastic sheet into a pliable forming temperature, the plastic sheet is formed to a specific shape in a mold (e.g., the shape of the object), and trimmed to create the germ guard label. Thermoforming can form thin germ guard labels (e.g., thin films less than 1.5 mm) that are removably attached to the objects without an adhesive that may leave residue on the lid upon removal. The thermoforming process can be included in a step in the object manufacturing process.

Additionally or alternatively, germ guard labels can be removably attached to the objects by utilizing properties of static electricity (e.g., static cling). Additionally or alternatively, germ guard labels can be removably attached to the objects by shrink wrapping the objects with the germ guard labels. By utilizing static cling or shrink wrap rather than adhesive, no residue is left on the object. The static cling or shrink wrap process can be included as a step in the object manufacturing process.

Additionally or alternatively, germ guard labels can be formed with a tab to facilitate removal of the germ guard label from the object. Tabs can be located at any area on the germ guard label that aid in the removal of the germ guard label. FIG. 1A illustrates a tab 102a located on the circumferential periphery of the germ guard label. FIG. 1B illustrates a tab 102b located near center of the germ guard label. FIG. 1C illustrates a tab 102c located on the radial periphery of the lid.

Additionally, tabs can be any shape or size smaller than the germ guard label. As shown, for example, in FIG. 1A, a tab 102a can be an approximately half-circular protrusion with a radius of between 0.1 millimeter and 50 millimeters. The tab 102a can be an approximately half-circular protrusion with a radius of between 0.5 millimeters and 10 millimeters. The tab 102a can be an approximately half-circular protrusion with a radius of between 1 millimeter and 5 millimeters. The tab can be approximately rectangular shaped, approximately triangularly shaped or any other shape that can facilitate removal of the germ guard label. Additionally or alternatively, as illustrated in FIGS. 1D and 1E, the germ guard label does not need a tab and can utilize other methods to facilitate removal of the germ guard label (e.g., perforations).

Additionally or alternatively, germ guard labels, as illustrated in FIG. 1A-1E, can be made of a food grade material, FDA-approved for oral contact. Germ guard labels can be made from a thin, flexible material (e.g., a thin film). Germ guard labels may also be made from a sturdier material (e.g., a thermoplastic). Germ guard labels can be made of a polymer (e.g., plastic), paper, paper coated with polymer, fiberboard, cellulosic material, or any combination thereof.

For example, the germ guard labels can include at least one of polylactide, polycarbonate (PC), polypropylene (PP), polyethylene (e.g., high-density polyethylene (HDPE), low density polyethylene (LDPE) or polyethylene terephthalate (PET)), polyvinyl chloride (PVC or vinyl), polystyrene (PS), etc. The germ guard label can include a biopolymer (e.g., cellulose or cellulose acetate). Furthermore, the germ guard label can be paper coated, laminated with plastic or otherwise covered with a plastic film. Additionally or alternatively, the germ guard label can be cellophane and/or a shrink film.

As illustrated in FIGS. 1A-1E, germ guard labels can be transparent, translucent, transparent with one or more colors or opaque with one or more colors. Germ guard labels can be any color or combination of colors. Germ guard labels can be any combination of shades of color or colors. Additionally or alternatively, germ guard labels can include any combination of graphic designs or logos.

Additionally or alternatively, as illustrated in FIGS. 1A-1E, the germ guard labels can be treated with antimicrobial agents or possess antimicrobial properties. For example, the germ guard labels can be treated with any FDA-approved antimicrobial agent, including chemical antimicrobials, antioxidants, biotechnology products, antimicrobial polymers, natural antimicrobials or gas. The germ guard labels may also be made from polymers or other materials inherently possessing antimicrobial capabilities. Additionally, the germ guard labels can have antimicrobial agents incorporated directly into polymers of the plastic food grade material or antimicrobial agents coated or absorbed onto the surface of the plastic food grade material. Antimicrobial germ guard labels can prevent or limit the spread of germs. Germ guard labels can also be treated with antimicrobial agents that, for example, provide protection against fungi or other contaminants. For example, the germ guard label can be imbibed and/or impregnated with the antimicrobial agent. Additionally or alternatively, the germ guard label can be treated with antimicrobial agent.

The antimicrobial agent can include a biocidal and/or a biostatic agent(s). The biocidal and/or biostatic agent may be capable of slowing or inhibiting the growth or reproduction of microorganisms, for example triclosan, including bacteria, molds, fungi, viruses and the like. Additionally, the biocidal agent may be a biocide (life destroying), which may be a bacteriacide and fungicide (inhibiting the growth of microorganisms and destroying the microorganisms). The biocide may also be antiviral. The biocide may be a broad spectrum biocide, and generally, a wide ranging antimicrobial, inhibiting a broad range of microorganisms. The antimicrobial may be effective at controlling or killing bacteria, such as gram positive, gram negative, aerobic and anaerobic types, viruses, fungi, etc. Any biocide that is compatible with the material of the germ guard label before fabrication and will retain its activity after fabrication may be used in connection with the germ guard label.

For example, the antimicrobial may be triclosan, which is a common name for 2,4,4′-trichloro-2′-hydroxydiphenol or 50chloro-2-(2,4,-dichlorophenoxy)phenol. Further for example, the antimicrobial may contain silver or silver ion. The antimicrobial may, additionally or alternatively, contain zinc or zinc ion. Additionally or alternatively, for example, the germ guard label can be polystyrene (PS) coated with a silver or silver ion-containing antimicrobial agent.

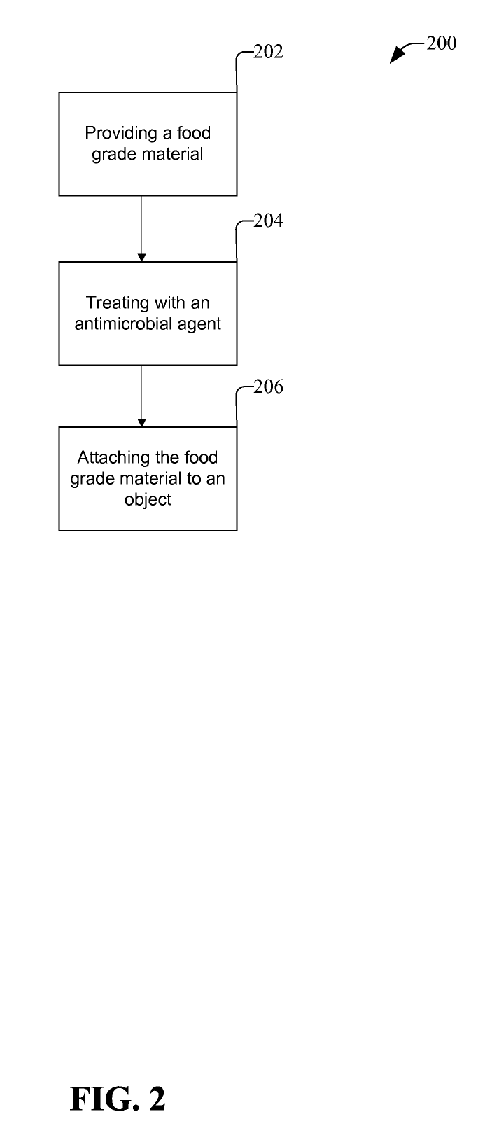

FIGS. 2-10 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts and with other acts not presented and described herein. Furthermore, not all illustrated acts may be required to implement the methodologies in accordance with the disclosed subject matter. Further, it can be appreciated that the order of acts shown is but one example, and the order of various acts shown may be interchanged or combined with other acts not shown without departing from the scope of the invention.

Regarding FIG. 2, illustrated is a method for making an article that prevents transmission of a contaminant from an object to a human. At 202, a food grade material can be provided. The food grade material can be any FDA-approved material for food contact. For example, the material can be plastic, paper, a combination of plastic and paper or any other FDA-approved material. The food grade material can be of a shape and thickness to at least correspond to an oral contact area of an object like a beverage container.

The food grade material can be treated with an antimicrobial agent at 204. The food grade material can be treated by the antimicrobial, for example, by impregnating or coating with the antimicrobial agent. The antimicrobial agent can be any FDA-approved antimicrobial agent. The antimicrobial agent can be active against one or more of bacteria, viruses, fungi or any other contaminant.

The antimicrobial agent can include a biocidal and/or a biostatic agent(s). The biocidal and/or biostatic agent may be capable of slowing or inhibiting the growth or reproduction of microorganisms, for example triclosan, including bacteria, molds, fungi, viruses and the like. Additionally, the biocidal agent may be a biocide (life destroying), which may be a bacteriacide and fungicide (inhibiting the growth of microorganisms and destroying the microorganisms). The biocide may also be antiviral. The biocide may be a broad spectrum biocide, and generally, a wide ranging antimicrobial, inhibiting a broad range of microorganisms. The antimicrobial may be effective at controlling or killing bacteria, such as gram positive, gram negative, aerobic and anaerobic types, viruses, fungi, etc. Any biocide that is compatible with the material of the germ guard label before fabrication and will retain its activity after fabrication may be used in connection with the germ guard label.

For example, the antimicrobial may be triclosan, which is a common name for 2,4,4′-trichloro-2′-hydroxydiphenol or 50chloro-2-(2,4,-dichlorophenoxy)phenol. Further for example, the antimicrobial may contain silver or silver ion. The antimicrobial may, additionally or alternatively, contain zinc or zinc ion.

At 206, the food grade material can be attached to the object. The food grade material can be physically attached utilizing, for example, chemical properties of the food grade material, mechanical properties of the food grade material or any other method of attachment (e.g., thermoforming or vacuumforming). The food grade material can cover at least a portion of an oral contact area of the object. The object can be, for example, a beverage container (e.g., a cup, a lid for a cup, a cup and lid in combination, an aluminum can, a glass bottle or a plastic bottle).

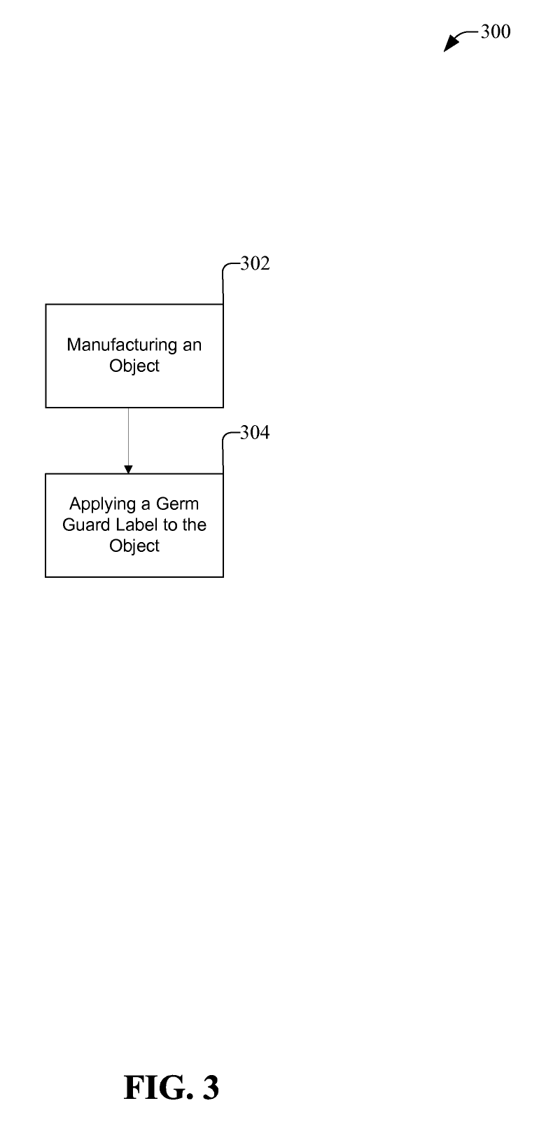

Regarding FIG. 3, illustrated is a method for applying a germ guard label to an object. At 302, an object can be manufactured as described above. At 304, a food grade material can be thermoformed to the object after manufacturing or as a step of the manufacturing process. The germ guard label can be attached to the object utilizing, for example, chemical properties of the food grade material, mechanical properties of the food grade material or any other method of attachment (e.g., thermoforming or vacuumforming). The germ guard label is conformal or substantially conformal to the object and covers the entire oral contact area. The object can include a beverage container (e.g., a cup, a lid, a cup and lid system or an aluminum can). The food grade material can act as a germ guard label that prevents transmission of a contaminant from an object to a human. The food grade material can be any food grade material that is FDA-approved for contact with food. For example, the food grade material can be paper, plastic or any combination of paper and plastic. Additionally, the food grade material can have antimicrobial properties or be treated with an agent having antimicrobial properties.

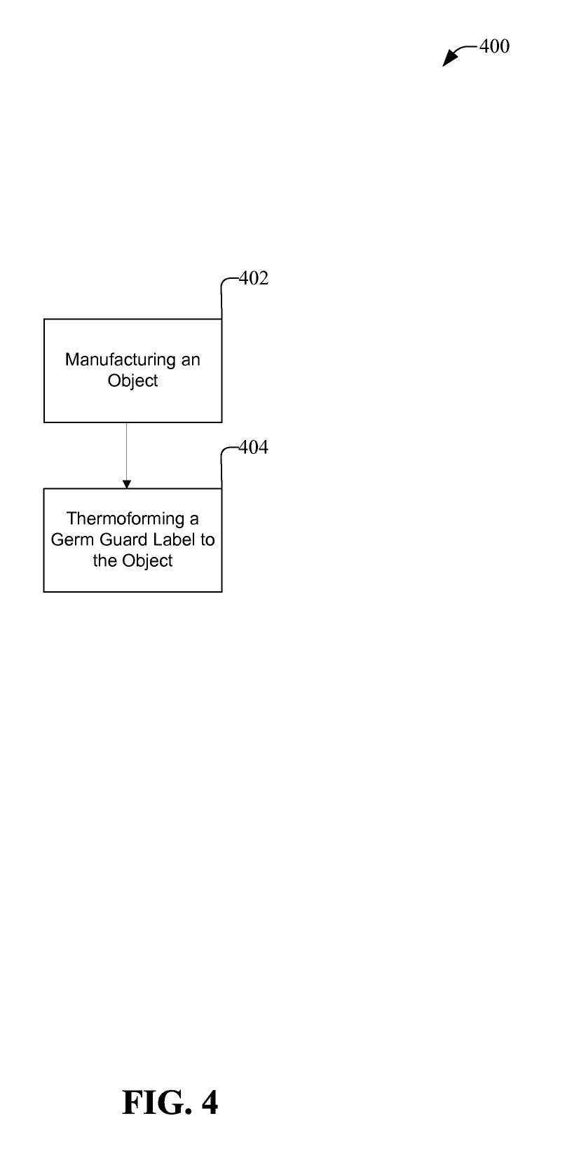

Regarding FIG. 4, illustrated is a method for applying a germ guard label to an object. At 402, the object is manufactured, as described above. At 404, the germ guard label is affixed to the aluminum can by a thermoforming process, which allows the germ guard label to be conformal or substantially conformal to the oral contact area of the can. Thermoforming is a method of manufacturing whereby sheets of thin plastic material area heated, then vacuum formed to a desired shape (e.g., a shape greater than or equal to the oral contact area of the aluminum can). Excess material is then cut away by die cutting. The thermoformed germ guard label is conformal or substantially conformal to the oral contact area of the aluminum can. Thermoforming can allow the germ guard lid (e.g., thin films with a thickness less than 1.5 mm) to be removably attached to the surface without an adhesive that may leave residue on the lid upon removal.

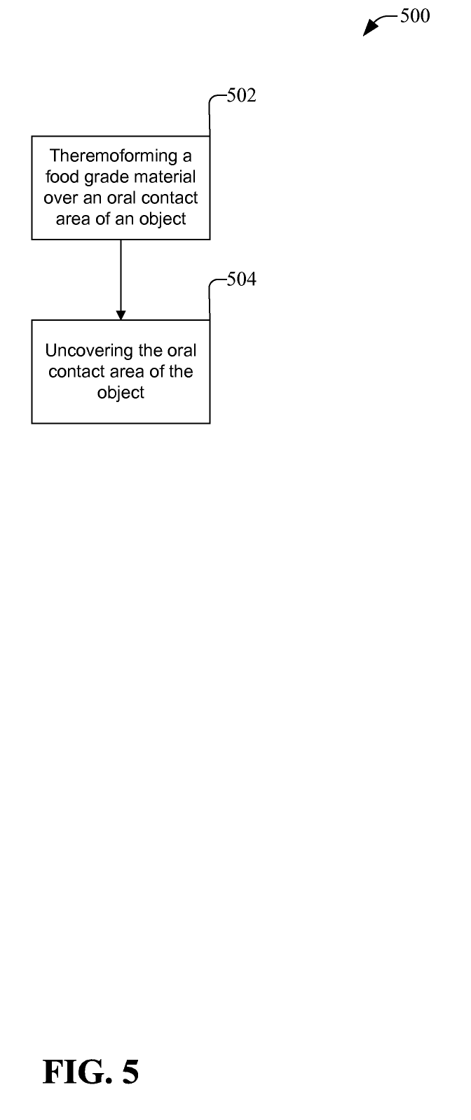

Regarding FIG. 5, illustrated is an illustration of a method for preventing transmission of germs from an object to a human. At 502, an oral contact area of an object (e.g., a beverage container, including at least one of a cup, a lid or an aluminum can) can be covered with a food grade material (e.g., by thermoforming or vacuumforming). The food grade material can be a label. The food grade material can have an antimicrobial property. For example, the antimicrobial property can be provided by treatment with an antimicrobial agent or through antimicrobial properties inherent to the food grade material. The food grade material can act as a shield that protects that oral contact area against contaminants, including germs like influenza, the common cold, staphylococcus or streptococcus.

At 504, the oral contact area can be uncovered by removing the food grade material from the oral contact area (e.g., by pulling a tab on the food grade material). After removal of the food grade material, the oral contact area can be free of germs or other contaminants.

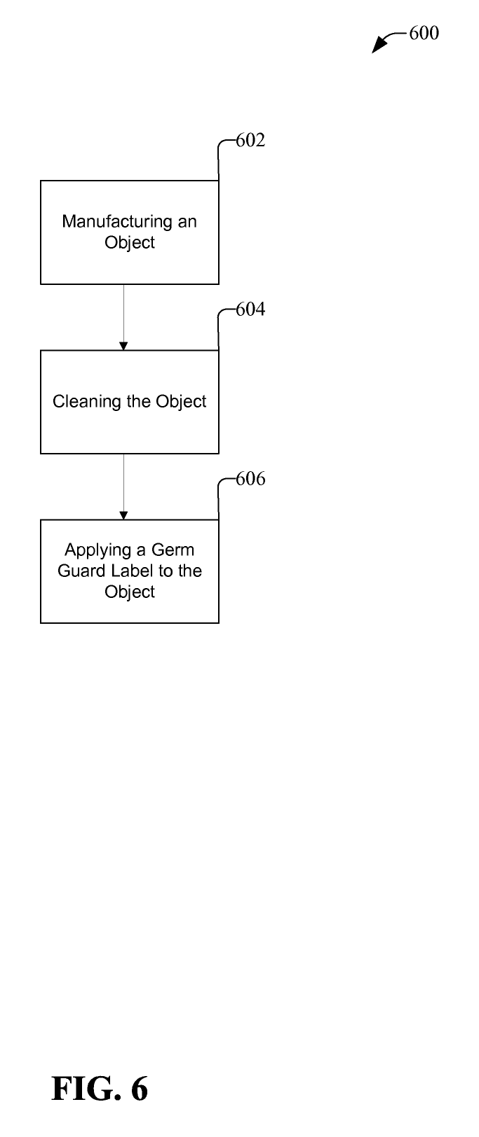

Regarding FIG. 6, illustrated is a method for applying a germ guard label to an object. At 602, the object is manufactured, as described above. At 604, the object is cleaned. The object can be cleaned, for example, to remove contaminants from the outside of the objects. For example, the object can be cleaned with a water rinse and/or a commercial cleanser. Additionally or alternatively, the object can be cleaned utilizing liquid acidic or alkaline cleaners. At 606, the germ guard label can be attached to the object in any manner to at least substantially conform to the oral contact area of the object.

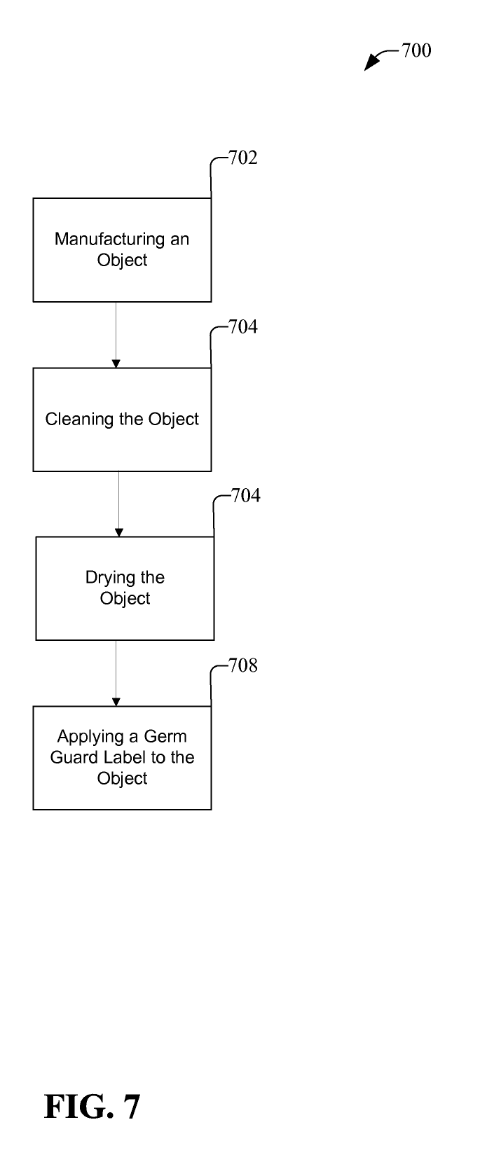

Regarding FIG. 7, illustrated is a method for applying a germ guard label to an object. At 702, the object is manufactured, as described above. At 704, the object is cleaned in any method as described above. At 706, the object is dried, for example, in an oven or spray-dried. At 708, the germ guard label can be attached to the object in any manner to at least substantially conform to the oral contact area of the object.

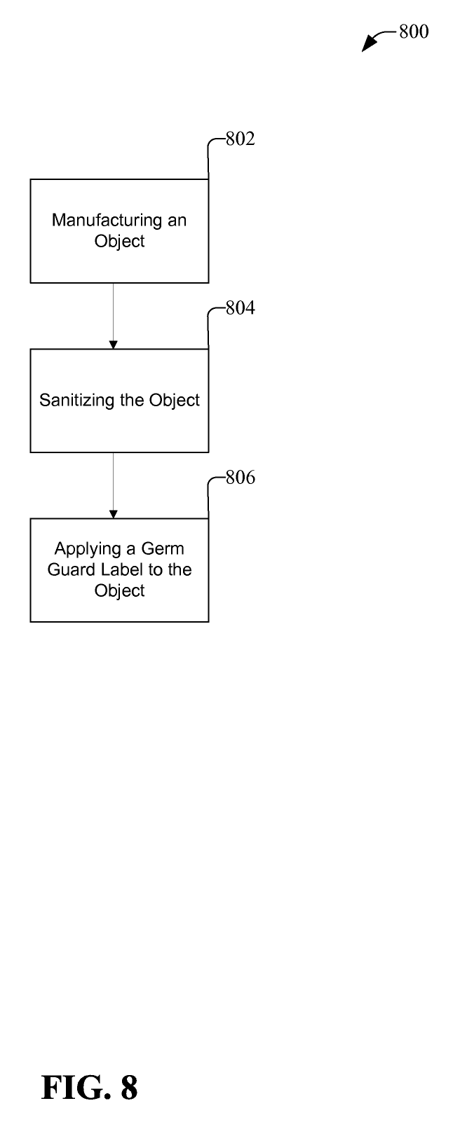

Regarding FIG. 8, illustrated is a method for applying a germ guard label to an object. At 802, the object is manufactured, as described above. At 804, the object is sanitized and/or sterilized to remove any germs from the surface. Any method of sanitization can be used, including thermal sanitization, ultraviolet sanitization, x-ray sanitization, or chemical sanitization. For example, the object may be sanitized using dry heat, wherein the object is exposed to a high temperature (e.g., greater than 100 degrees Celsius) for a period of time (e.g., greater than 1 hour). At 806, the germ guard label can be attached to the object in any manner to at least substantially conform to the oral contact area of the object.

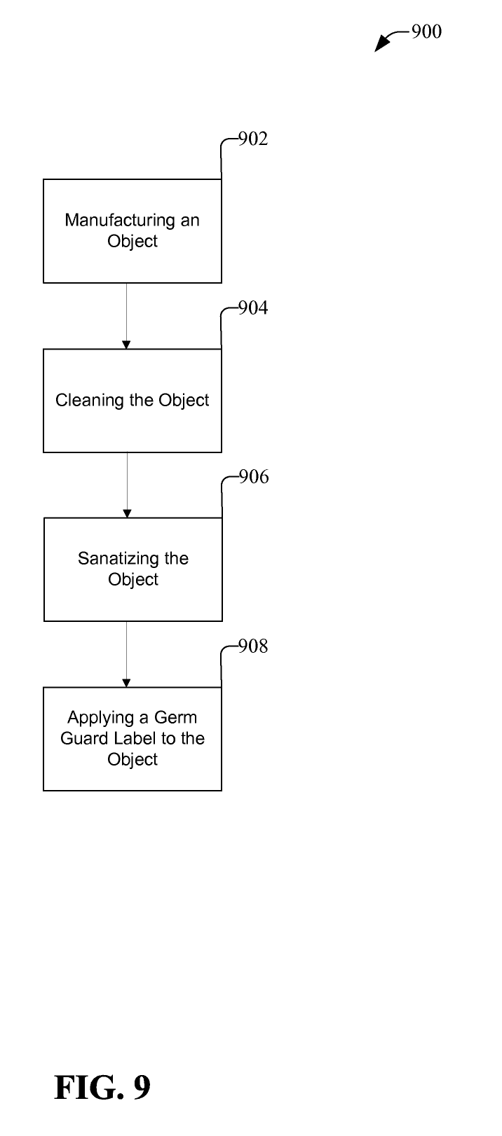

Regarding FIG. 9, illustrated is a method for applying a germ guard label to an aluminum can. At 902, the object is manufactured, as described above. At 904, the object is cleaned to remove any dirt or contaminants using any method as described above. At 906, the object is sanitized and/or sterilized to remove any germs from the surface using any method as described above. At 908, the germ guard label can be attached to the object in any manner to at least substantially conform to the oral contact area of the aluminum can. Accordingly, the germ guard label can be attached to a clean, sterile surface.

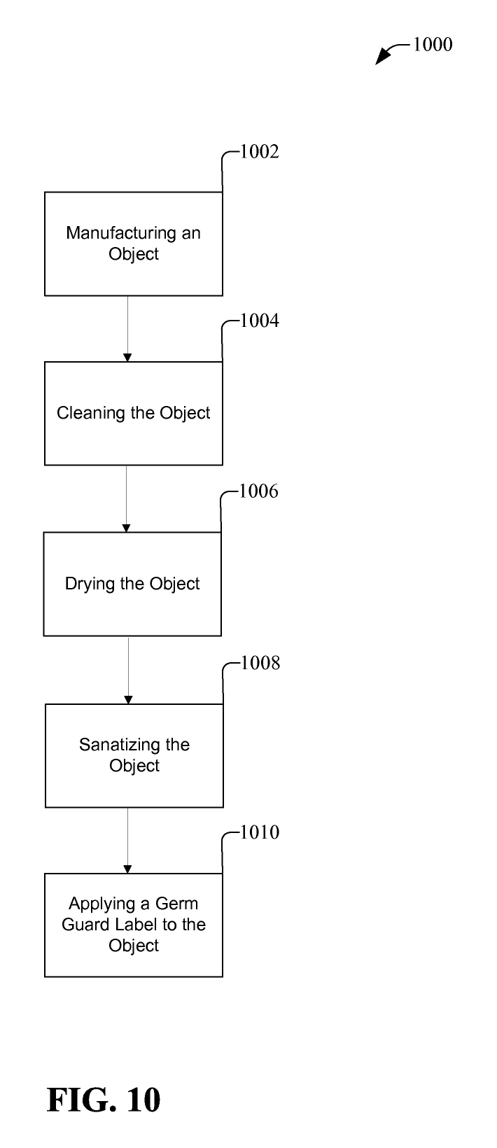

Regarding FIG. 10, illustrated is a method for applying a germ guard label to an object. At 1002, the object is manufactured, as described above. At 1004, the object is cleaned to remove any dirt or contaminants using any method as described above. At 1006, the object is dried using any method as described above. At 1008, the object is sanitized and/or sterilized to remove any germs from the surface using any method as described above. At 910, the germ guard label can be attached to the object in any manner to at least substantially conform to the oral contact area of the object. Accordingly, the germ guard label can be attached to a clean, sterile surface and the surface will still be clean and sterile when the germ guard label is removed.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

What has been described above includes examples of the present specification. It is, of course, not possible to describe every conceivable combination of components or methodologies for purposes of describing the present specification, but one of ordinary skill in the art may recognize that may further combinations and permutations of the present specification are possible. Accordingly, the present specification is intended to embrace all such alterations, modifications and verifications that fall within the spirit and scope of the appended claims. In addition, while a particular feature of the invention may have been disclosed with respect to only one of several embodiments, such feature may be combined with one or more other features of the other embodiments as may be desired and advantageous for any given or particular application. Furthermore, to the extent that the term “includes” is used either in the detailed description or the claims, such term is intended to be inclusive in a manner similar to the term “comprising” as “comprising” is interpreted when employed as a transitional word in a claim.

What is claimed is:

1. A label that prevents contaminant transmission, comprising:
a food grade material having a shape sufficient to at least correspond to an oral contact area of an object and removably attachable to the object,
wherein the food grade material is at least substantially conformal to the object.

2. The label of claim 1, wherein the food grade material possesses antimicrobial properties.

3. The label of claim 1, wherein the food grade material is treated with an antimicrobial agent.

4. The label of claim 3, wherein the antimicrobial agent comprises at least one of: silver, silver ion, zinc or zinc ion.

5. The label of claim 1, wherein the object is a lid for a cup.

6. The label of claim 1, wherein the object is cylindrical-shaped can with a top lid comprising the oral contact area.

7. The label of claim 6, wherein the food grade material having a shape sufficient to correspond to at least the top lid of the object.

8. The label of claim 6, wherein the food grade material having a shape sufficient to correspond to an area greater than the top lid of the object.

9. The label of claim 1, wherein the food grade material is removably attachable to the object by a thermoforming process.

10. An article, comprising:
a beverage container;
a food grade material having a shape sufficient to at least correspond to an oral contact area of the beverage container; and
an antimicrobial agent.

11. The article of claim 10, wherein the beverage container is a lid for a cup, a pull-top can or a bottle.

12. The article of claim 10, wherein the food grade material is removably attachable to the beverage container.

13. A method for preventing transmission of germs from an object to a human, comprising:
providing a food grade material in a shape sufficient to correspond to at least an oral contact area of the object;
treating the food grade material with an antimicrobial agent, and
attaching the food grade material to the object.

14. The method of claim 13, wherein attaching the food grade material further comprises thermoforming the food grade material to the object.

15. The method of claim 13, wherein attaching the food grade material further comprising shrinking the food grade material over the object.

16. The method of claim 13, further comprising removing the food grade material from at least the oral contact area of the object.

17. The method of claim 16, further comprising providing an uncontaminated oral contact area of the object.

18. The method of claim 13, wherein providing the food grade material further comprises providing the food grade material in a shape sufficient to cover at least top lid of a cylindrical can.

19. The method of claim 13, wherein the antimicrobial agent comprises at least one of: silver, silver ion, zinc or zinc ion.

20. The method of claim 13, wherein providing the food grade material further comprises providing the food grade material with perforations facilitating removal of the food grade material from the object.
